(19) United States
(12) Patent Application Publication
(10) Pub. No.: US 2026/0369059 A1
(43) Pub. Date: Nov. 19, 2026

(54) Real-Time Multimodal Classroom Observation System with Transcript-Enhanced Cross-Attention Fusion and Rule-Based Adaptive Sampling (Edge-Only Execution)

(71) Applicant: Jeremy Miller, Cherokee Village, AR (US)

(72) Inventor: Jeremy Miller, Cherokee Village, AR (US)

(21) Appl. No.: 19/677,968

(22) Filed: May 14, 2026

Related U.S. Application Data
(60) Provisional application No. 63/806,018, filed on May 15, 2025.

(51) Int. Cl. G06V 20/40; G06F 21/62; G06V 10/764; G06V 40/20; G10L 15/26; G10L 21/034; G10L 25/18; G10L 25/57; H04N 23/71

(52) U.S. Cl. CPC G06V 20/44; G06F 21/6254; G06V 10/764; G06V 20/41; G06V 40/20; G10L 15/26; G10L 21/034; G10L 25/18; G10L 25/57; H04N 23/71

(57) ABSTRACT

An edge-only classroom observation system performs real-time multimodal classroom event detection while limiting transmission of raw classroom media. An edge device captures classroom video and audio, generates transcript data locally using an on-device speech-to-text engine, and produces video, audio, and transcript token embeddings. A transformer encoder fuses the embeddings through cross-modal attention in a unified attention architecture that does not use learned gating networks or mixture-of-experts routing to select modality-specific experts. A deterministic adaptive sampling engine adjusts camera or microphone capture parameters using threshold rules based on locally measured brightness and audio level or noise conditions, without reinforcement learning capture control. A quantized inference pipeline classifies classroom behavioral or instructional events locally and publishes abstract event metadata to a dashboard while withholding raw video, audio, and transcript text from transmission for event classification.

### CROSS-REFERENCE TO RELATED APPLICATIONS

This application claims the benefit of U.S. Provisional Patent Application No. 63/806,018, filed May 15, 2025, entitled “Real-Time Multimodal Classroom Observation System with Transcript-Enhanced Cross-Attention Fusion and Rule-Based Adaptive Sampling (Edge-Only Execution),” the disclosure of which is relied upon for priority to the extent permitted by law.

### STATEMENT REGARDING FEDERALLY SPONSORED RESEARCH OR DEVELOPMENT

Not applicable.

### FIELD OF THE INVENTION

The present disclosure relates generally to educational technology, computer vision, audio processing, speech processing, and edge artificial intelligence. More particularly, the disclosure relates to on-device systems and methods for detecting and classifying classroom instructional or behavioral events using locally fused video, audio, and transcript-derived signals while restricting transmission of raw classroom media and raw transcript content from the device.

### BACKGROUND OF THE INVENTION

Classroom observation and teacher evaluation processes commonly rely on in-person observation, manually reviewed video, written notes, or cloud-based analytics. These approaches may require substantial administrator time, introduce latency between classroom activity and feedback, and create privacy concerns when classroom video, audio, or student speech content is transferred to external servers.

Known educational analytics systems may process video, audio, or transcript data to assess engagement, discourse quality, or instructional practice. However, such systems often depend on remote computing resources, delayed post-lesson analysis, separate modality-specific models, or generalized multimodal pipelines that are not designed around K-12 privacy constraints and real-time administrative feedback requirements.

Known multimodal artificial intelligence architectures may use learned gating, mixture-of-experts routing, modality selection, or reinforcement learning based sensor control. While such approaches can be powerful, they may increase model complexity, increase compute requirements, require training data for control policies, and make on-device execution more difficult in resource-limited school environments.

There remains a need for a classroom observation architecture that performs multimodal event detection locally on an edge device, fuses video, audio, and transcript-derived features in a unified attention architecture, uses deterministic rule-based capture adaptation rather than learned policy control, and outputs only abstract event metadata suitable for teacher feedback, administrator review, or educational analytics.

### SUMMARY OF THE INVENTION

In one aspect, an edge-only classroom observation system includes a classroom edge device having at least one camera, at least one microphone, an on-device speech-to-text engine, one or more processors, and memory storing instructions for performing local multimodal event classification.

The system generates, on the edge device, video frame embeddings from classroom image data, audio embeddings from audio or spectrogram data, and transcript token embeddings from locally generated speech transcript data. The embeddings are supplied to a transformer encoder configured to perform cross-modal attention among the video, audio, and transcript modalities within a shared attention architecture.

In preferred embodiments, the transformer encoder does not use a learned gating network, a mixture-of-experts routing mechanism, or a modality-router that selects among modality-specific expert networks. Instead, the modalities jointly attend to one another through attention operations in a unified encoder to produce a fused feature representation for classroom event classification.

The system further includes a rule-based adaptive sampling engine that measures environmental conditions such as ambient brightness and audio RMS or noise level. The adaptive sampling engine applies deterministic threshold rules to adjust capture parameters, including camera frame rate, exposure, microphone gain, audio capture level, or sampling interval, without using reinforcement learning or a learned capture-control policy.

The system performs quantized inference locally, such as post-training static INT8 quantized inference on an edge accelerator, neural processing unit, tensor processing unit, graphics processor, digital signal processor, or other local compute hardware. In some embodiments, classification latency is less than 100 milliseconds and end-to-end dashboard update latency is less than 200 milliseconds.

The system publishes only abstracted behavioral or instructional event metadata, such as an event label, timestamp, confidence value, classroom session identifier, or actor role indicator, through a local or networked event stream such as MQTT, WebSocket, HTTP/2, or a JSON-based message protocol. Raw classroom video, raw classroom audio, and raw transcript text are not transmitted from the edge device to a cloud service for classification.

### BRIEF DESCRIPTION OF THE DRAWINGS

FIG. 1 is a block diagram of an edge-only classroom observation system including a camera, microphone, speech-to-text engine, multimodal fusion module, adaptive sampling engine, quantized inference pipeline, and administrator user interface.

FIG. 2 is a data flow diagram showing video frame embeddings, audio spectrogram embeddings, and transcript token embeddings supplied to a cross-modal attention layer to generate a unified feature representation.

FIG. 3 is a flowchart showing deterministic rule-based adaptive sampling based on ambient brightness and audio noise conditions.

FIG. 4 is a sequence diagram showing capture, local fusion, local inference, event publication, and dashboard update with abstract event metadata.

### DETAILED DESCRIPTION OF THE INVENTION

The following description provides exemplary embodiments of the invention. The embodiments are not intended to limit the scope of the claims unless expressly recited in the claims. Features described in connection with one embodiment may be combined with features of another embodiment unless the context clearly indicates otherwise.

As used herein, an “edge device” means a computing device that performs capture, preprocessing, feature extraction, fusion, and event classification locally at or near the classroom environment. The edge device may be a dedicated classroom appliance, a tablet, a laptop, an embedded computer, a single-board computer, a smart camera, or another local device having sufficient processing capability.

As used herein, “raw classroom media” includes unprocessed or substantially reconstructable classroom video, classroom audio, or classroom transcript text. “Abstract event metadata” includes non-media information describing a detected event, such as an event class, event confidence, timestamp, duration, location within a frame, anonymized actor identifier, actor role, or classroom session identifier.

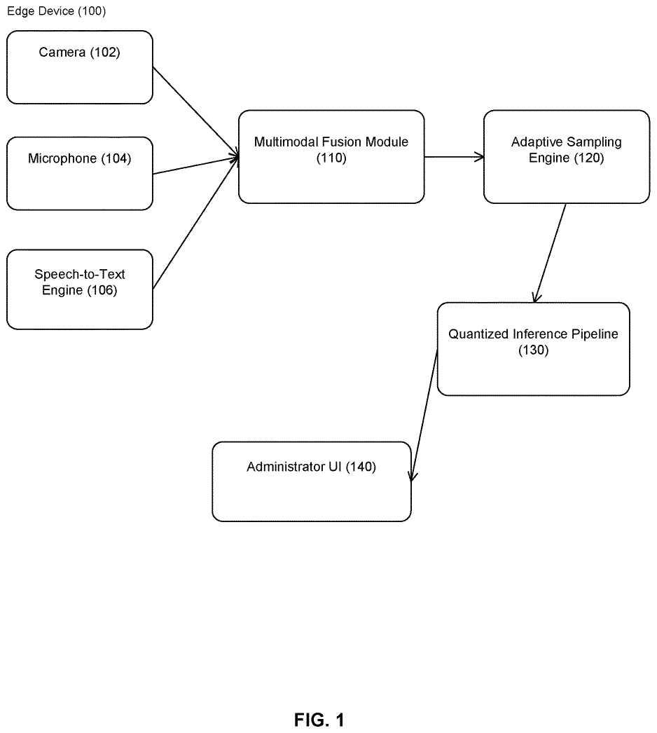

Referring to FIG. 1, an edge device 100 includes a camera 102, a microphone 104, and a speech-to-text engine 106. The edge device 100 may be positioned in a classroom and configured to capture video frames and audio samples during an instructional session. The speech-to-text engine 106 generates transcript tokens or text locally from classroom audio without sending the audio to an external speech service.

The edge device 100 includes a multimodal fusion module 110. In one embodiment, the multimodal fusion module 110 receives video frame embeddings generated from captured video frames, audio spectrogram embeddings generated from audio samples, and transcript token embeddings generated from locally produced transcript data. Video embeddings may be generated by a convolutional neural network, a vision transformer, a lightweight feature extractor, or another on-device image feature model. Audio embeddings may be generated from mel-spectrograms, log-mel features, audio transformer features, or other audio representations. Transcript token embeddings may be generated using a token embedding layer, a transformer language encoder, or another text representation model executed locally.

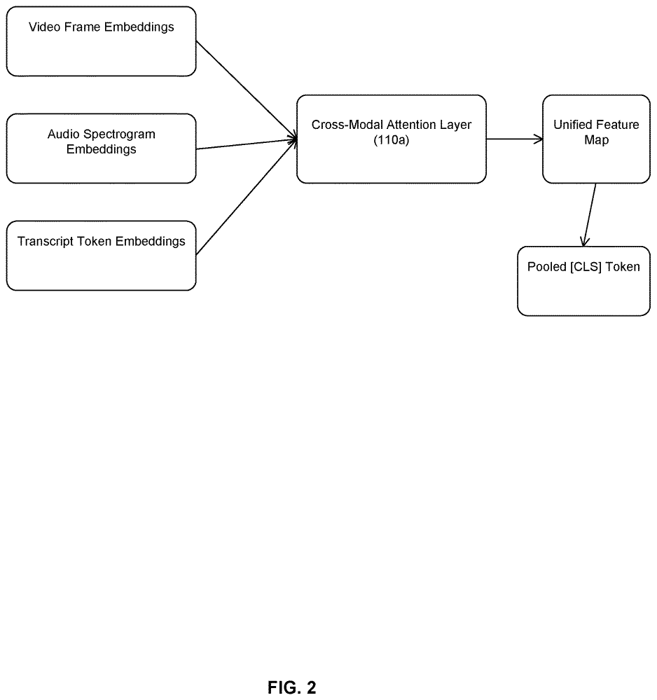

Referring to FIG. 2, the video frame embeddings, audio spectrogram embeddings, and transcript token embeddings are synchronized by timestamp or by a shared temporal window and supplied to a cross-modal attention layer 110a of a transformer encoder. In one implementation, each modality provides query, key, and value representations, and attention heads compute relationships across video, audio, and transcript tokens. The output of the transformer encoder may include a pooled classification token, pooled temporal representation, or other unified feature map used to classify classroom events.

The transformer encoder preferably processes the modalities within a unified attention architecture. In such embodiments, the system does not use a learned gating network, does not select among modality-specific expert networks through a mixture-of-experts router, and does not route entire modality streams to different expert branches using a learned modality-routing policy. Rather, the architecture allows the modalities to jointly attend to one another within shared attention layers, thereby reducing model-control complexity and supporting predictable on-device execution.

The multimodal fusion module 110 may classify events such as hand raising, low engagement, student participation, teacher questioning, teacher wait time, off-task behavior, student response, group discussion, classroom transition, or other instructional or behavioral events relevant to observation, coaching, evaluation support, or administrative analytics. Event labels may be mapped to a school-defined observation framework without requiring raw media to leave the classroom device.

The edge device 100 also includes an adaptive sampling engine 120. The adaptive sampling engine 120 continuously or periodically computes one or more environmental measurements from locally available sensor data. For example, the adaptive sampling engine 120 may compute average frame brightness, local contrast, exposure value, audio RMS, signal-to-noise ratio, peak audio level, or background-noise estimate.

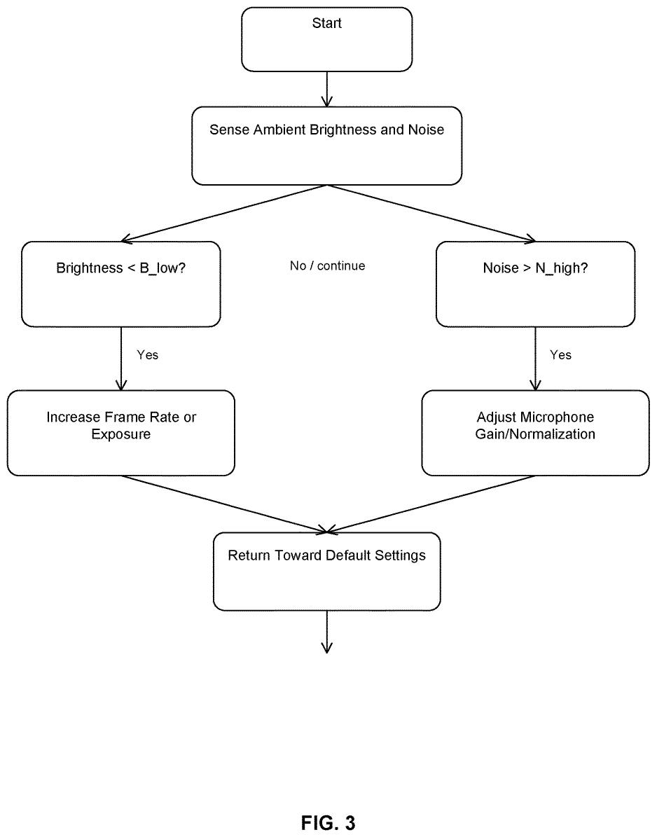

Referring to FIG. 3, the adaptive sampling engine 120 applies deterministic threshold-based rules to adjust capture parameters. In one example, if brightness is below a lower brightness threshold B_low, the system increases camera frame rate, exposure, sensor gain, or frame sampling density within a predefined maximum. If brightness is above an upper brightness threshold B_high, the system decreases the corresponding capture parameter or returns the parameter toward a default value. In another example, if audio noise or RMS exceeds a threshold N_high, the system increases or decreases microphone gain, modifies an audio normalization parameter, or adjusts sampling for improved speech capture. When the condition is no longer satisfied, the system reverts toward a default setting.

The adaptive sampling engine 120 uses fixed rules, lookup tables, hysteresis bands, or administrator-configured thresholds rather than reinforcement learning, reward-based policy optimization, or learned sensor-control policies. This permits predictable behavior, easier auditing, lower training burden, and reduced compute requirements in K-12 environments.

A non-limiting example of deterministic sampling logic is: if brightness is less than B_low, set fps to min(fps_max, fps plus delta_fps); else if brightness is greater than B_high, set fps to max(fps_min, fps minus delta_fps). A further non-limiting example is: if noise is greater than N_high, set mic_gain to min(gain_max, gain plus delta_gain); otherwise return mic_gain toward a default gain.

The edge device 100 further includes a quantized inference pipeline 130. In one embodiment, a trained full-precision model is converted through post-training static quantization using calibration data to produce an INT8 model with quantized weights and activations. The INT8 model may execute on a neural processing unit, tensor processing unit, digital signal processor, graphics processor, or central processing unit located on the edge device. In certain implementations, the quantized inference pipeline 130 produces an event classification in less than 100 milliseconds.

The quantized inference pipeline 130 may receive the unified feature representation from the multimodal fusion module 110 and output event classifications, confidence values, temporal boundaries, or short event descriptors. The model may be calibrated using representative classroom audio, video, and transcript features while maintaining privacy constraints.

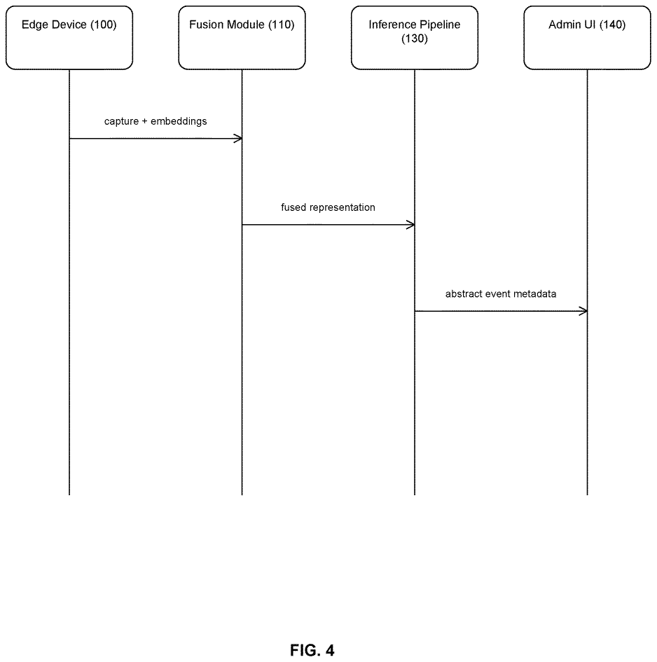

Referring to FIG. 4, after local classification, the edge device 100 publishes event metadata to an administrator user interface 140. The event metadata may be formatted as JSON and communicated through MQTT, WebSocket, HTTP/2, local network messaging, or another event stream. A representative event message may include fields such as {“event”:“hand_raise”, “timestamp”:“2026-05-14T10:15:03.125”, “confidence”:0.91, “session”:“classroom_7”, “actor_role”:“student”}.

The administrator user interface 140 may display events in real time, update an observation dashboard, generate time-aligned feedback prompts, summarize instructional patterns, or assist an administrator in preparing teacher feedback. In some embodiments, dashboard updates occur less than 200 milliseconds after event classification.

The system restricts transmission of raw classroom video, raw classroom audio, and raw transcript text. In one embodiment, raw media and transcript content are retained only in temporary local memory buffers for the minimum time needed for feature extraction and classification. In another embodiment, any locally retained data are encrypted, overwritten, downsampled, anonymized, or stored only after administrator authorization. The remote user interface receives abstract event metadata rather than raw classroom media.

The system may include local policy controls defining which event types are emitted, which metadata fields are transmitted, whether confidence scores are included, whether actor identifiers are anonymized, and whether any local media retention is allowed. These controls may be configured to align with school district privacy rules, parental consent requirements, teacher evaluation policies, or applicable law.

Although certain embodiments describe a K-12 classroom, the same architecture may be used in professional development, higher education, tutoring, clinical training, workforce training, or other instructional environments. However, the preferred implementation is designed for classroom observation and teacher evaluation support where privacy, latency, and administrator workflow are central design constraints.

Although MQTT, WebSocket, and JSON are described as examples, other structured event protocols may be used. Although INT8 quantization is preferred for efficient edge execution, other quantization formats or compression methods may be used when consistent with on-device execution. Although camera frame rate and microphone gain are described as adjustable parameters, other capture parameters may also be adjusted using deterministic thresholds.

What is claimed is:

1. A classroom observation system comprising:
an edge computing device located in or proximate to a classroom, the edge computing device comprising at least one camera, at least one microphone, an on-device speech-to-text engine, one or more processors, and memory storing instructions that, when executed by the one or more processors, cause the edge computing device to:
capture classroom video frames using the at least one camera and classroom audio samples using the at least one microphone;
generate, on the edge computing device, transcript data from the classroom audio samples using the on-device speech-to-text engine;
generate video frame embeddings from the classroom video frames, audio embeddings from the classroom audio samples or spectrograms derived from the classroom audio samples, and transcript token embeddings from the transcript data;
supply the video frame embeddings, the audio embeddings, and the transcript token embeddings to a transformer encoder configured to perform cross-modal attention among video, audio, and transcript modalities in a unified attention architecture without selecting among modality-specific expert networks using a learned gating network or mixture-of-experts router;
determine, locally on the edge computing device, an ambient brightness condition and an audio level or noise condition;
adjust at least one capture parameter of the at least one camera or the at least one microphone using deterministic threshold rules based on the ambient brightness condition and the audio level or noise condition, without using a reinforcement learning policy for capture-parameter control;
perform quantized local inference using a fused representation output by the transformer encoder to classify a classroom behavioral or instructional event; and
transmit abstract event metadata corresponding to the classified classroom behavioral or instructional event to a user interface while preventing raw classroom video, raw classroom audio, and raw transcript text from being transmitted from the edge computing device for event classification.

2. The classroom observation system of claim 1, wherein the quantized local inference comprises INT8 inference executed on a neural processing unit, tensor processing unit, graphics processor, digital signal processor, or other local accelerator of the edge computing device.

3. The classroom observation system of claim 1, wherein the quantized local inference is performed using a model produced by post-training static quantization with representative calibration data.

4. The classroom observation system of claim 1, wherein the classroom behavioral or instructional event comprises at least one of a hand-raise event, low-engagement event, student-participation event, teacher-questioning event, student-response event, off-task event, group-discussion event, or classroom-transition event.

5. The classroom observation system of claim 1, wherein the transformer encoder outputs a pooled classification token or pooled temporal representation as the fused representation used to classify the classroom behavioral or instructional event.

6. The classroom observation system of claim 1, wherein the unified attention architecture excludes learned modality-routing logic that routes a complete modality stream to a different expert branch based on a learned routing score.

7. The classroom observation system of claim 1, wherein the deterministic threshold rules comprise increasing a camera frame rate, exposure parameter, or frame sampling density when measured brightness is below a lower brightness threshold.

8. The classroom observation system of claim 1, wherein the deterministic threshold rules comprise decreasing a camera frame rate, exposure parameter, or frame sampling density when measured brightness is above an upper brightness threshold.

9. The classroom observation system of claim 1, wherein the deterministic threshold rules comprise adjusting microphone gain or an audio normalization parameter when an audio RMS value, noise estimate, or signal-to-noise measure satisfies a predetermined audio threshold.

10. The classroom observation system of claim 1, wherein the instructions further cause the edge computing device to return the at least one capture parameter toward a default value when the ambient brightness condition or the audio level or noise condition no longer satisfies a corresponding threshold condition.

11. The classroom observation system of claim 1, wherein the abstract event metadata is formatted as a JSON message and transmitted using MQTT, WebSocket, HTTP/2, or another event-stream protocol.

12. The classroom observation system of claim 1, wherein the abstract event metadata comprises an event label, timestamp, confidence value, classroom session identifier, anonymized actor identifier, actor role indicator, event duration, or frame-region descriptor.

13. The classroom observation system of claim 1, wherein the edge computing device classifies the classroom behavioral or instructional event with an inference latency of less than 100 milliseconds.

14. The classroom observation system of claim 1, wherein the user interface is updated based on the abstract event metadata within less than 200 milliseconds after event classification.

15. A computer-implemented method for privacy-preserving classroom observation, the method comprising:
capturing, by an edge computing device in or proximate to a classroom, classroom video frames and classroom audio samples; generating, by an on-device speech-to-text engine of the edge computing device, transcript data from the classroom audio samples; generating, locally on the edge computing device, video frame embeddings, audio spectrogram embeddings, and transcript token embeddings; processing the video frame embeddings, audio spectrogram embeddings, and transcript token embeddings using a transformer encoder having cross-modal attention among video, audio, and transcript modalities within a unified attention architecture that omits learned gating networks and mixture-of-experts routing for selecting modality-specific expert networks; measuring, locally on the edge computing device, brightness and audio noise or level conditions; modifying one or more capture settings according to deterministic threshold rules responsive to the brightness and audio noise or level conditions, without reinforcement learning based capture control; classifying, locally on the edge computing device, a classroom behavioral or instructional event using a quantized inference model; and publishing abstract event metadata representing the classroom behavioral or instructional event to a dashboard while withholding raw classroom video, raw classroom audio, and raw transcript text from transmission to the dashboard or to a cloud service for event classification.

16. The computer-implemented method of claim 15, further comprising discarding, overwriting, encrypting, or retaining only locally raw classroom video, raw classroom audio, or raw transcript text after embeddings are generated.

17. The computer-implemented method of claim 15, further comprising temporally aligning the video frame embeddings, audio spectrogram embeddings, and transcript token embeddings within a shared time window before processing the embeddings using the transformer encoder.

18. A non-transitory computer-readable medium storing instructions that, when executed by one or more processors of an edge classroom observation device, cause the edge classroom observation device to:
generate local video, audio, and transcript-derived embeddings from classroom sensor data;
fuse the local video, audio, and transcript-derived embeddings using a transformer encoder configured for cross-modal attention without learned gating or mixture-of-experts modality routing;
adapt at least one video or audio capture parameter using deterministic threshold-based rules based on locally measured brightness or audio level conditions;
classify, using quantized on-device inference, a classroom behavioral or instructional event; and
output only abstract event metadata corresponding to the classroom behavioral or instructional event to a remote or local user interface.

19. The non-transitory computer-readable medium of claim 18, wherein the instructions further cause the edge classroom observation device to perform post-training static INT8 quantized inference on a local accelerator and to classify the classroom behavioral or instructional event without transmitting raw classroom media to a remote server.

20. The non-transitory computer-readable medium of claim 18, wherein the abstract event metadata is transmitted as a structured event message comprising an event label and timestamp for real-time teacher observation feedback or educational administrative analytics.
